(19) United States
(12) Patent Application Publication
(10) Pub. No.: US 2014/0168531 A1
(43) Pub. Date: Jun. 19, 2014

(54) POLARIZATION UNIT WITH TOUCH FUNCTION

(71) Applicant: Chih-Chung Lin, Taipei City (TW)

(72) Inventor: Chih-Chung Lin, Taipei City (TW)

(21) Appl. No.: 13/760,061

(22) Filed: Feb. 6, 2013

(30) Foreign Application Priority Data
Dec. 19, 2012 (TW) 101148206

(51) Int. Cl. G02F 1/1333; G06F 3/041

(52) U.S. Cl. CPC G02F 1/13338; G06F 3/041
USPC 349/12; 345/174

(57) ABSTRACT

The present invention provides a polarization unit with touch functions, including a first polarization plate and an inductive electrode layer. The first polarization plate has a first side and a second side opposite to the first side. The inductive electrode layer is disposed on the first side of the first polarization plate. By means of the polarization unit of the present invention being applied to an LCD module, the manufacturing yield can be increased and the touch functions of the LCD module can be fulfilled.

This application claims the priority benefit of Taiwan patent application number 101148206 filed on Dec. 19, 2012.

### BACKGROUND OF THE INVENTION

1. Field of the Invention

The present invention relates to a polarization unit and in particular to a polarization unit with touch functions and high manufacturing yield.

2. Description of Prior Art Recently, various flat display devices have been developed, such as the liquid crystal display (LCD), field emission display (FED), plasma display panel (PDP), and light emitting display (LED). Among the above flat display devices, the LCD device has been widely used due to advantageous features such as low power consumption, thin profile, and enhanced brightness.

The LCD device of the prior art provides only video images for observers and can not provide the touch functions for interaction with the observers; hence an embedded touch LCD device has been developed by the industry. During the assembling of the embedded touch LCD device, the touch sensing electrodes are integrated into the display panel such that the display panel itself has the touch function.

Though the embedded touch LCD device of the prior art has the touch function, another problem occurs. That is the manufacturing process of the display panel of the LCD device of the prior art is different from that of the embedded touch LCD device such that a simplified manufacturing process can not be achieved and because the touch sensing electrodes of the embedded touch LCD device are disposed in the display panel, it is really difficult to maintain or replace the touch sensing electrodes when damage or contact failure of the touch sensing electrode is detected. Accordingly, the glass substrate and touch sensing electrodes thereon in a new display panel have to be replaced and the manufacturing cost is increased.

Besides, during the manufacturing process of the display panel of the embedded touch LCD device, the x-axis and y-axis sensing electrodes of the touch sensing electrodes have to be bridged and need more manufacturing masks, resulting in increased manufacturing process steps.

The above prior art suffers the following disadvantages:
1. low manufacturing yield;
2. increased manufacturing cost; and
3. the production and assembling processes can not be simplified and the sensing electrodes can not be uninstalled, inspected, and maintained easily.

Therefore, how to overcome the above problems and disadvantages is the focus which the inventor and the related manufacturers in this industry have been devoting themselves to.

### SUMMARY OF THE INVENTION

Thus, to effectively overcome the above problems, the primary objective of the present invention is to provide a polarization unit with touch functions to fulfill the touch function.

Another objective of the present invention is to provide a polarization unit with touch functions which has an increased manufacturing yield and low manufacturing cost.

The yet another objective of the present invention is to provide a polarization unit with touch functions which can be produced and assembled easily, and replaced and maintained conveniently.

To achieve the above objectives, the present invention provides a polarization unit with touch functions including a first polarization plate and an inductive electrode layer. The first polarization plate has a first side and a second side opposite to the first side. The inductive electrode layer is disposed on the first side of the first polarization plate. By means of the design of the inductive electrode layer disposed on the first polarization plate applied to an LCD module, the resultant LCD module can fulfill the touch functions. Further, the manufacturing yield can be effectively increased, the production and assembling processes can be simplified, and the LCD module can be conveniently uninstalled and replaced or maintained.

### BRIEF DESCRIPTION OF DRAWING

FIG. 1 is a perspective view of the polarization unit according to the first preferred embodiment of the present invention;

FIG. 2 is another perspective view of the polarization unit according to the first preferred embodiment of the present invention from another view;

FIG. 3 is a combined perspective view of the polarization unit according to the second preferred embodiment of the present invention;

FIG. 4 is a combined cross-sectional view of the polarization unit according to the second preferred embodiment of the present invention; and

FIG. 5 is an exploded cross-sectional view of the polarization unit according to the second preferred embodiment of the present invention.

### DETAILED DESCRIPTION OF THE INVENTION

The above objectives of the present invention and the features of structure and function of the present invention are described according to preferred embodiments in figures.

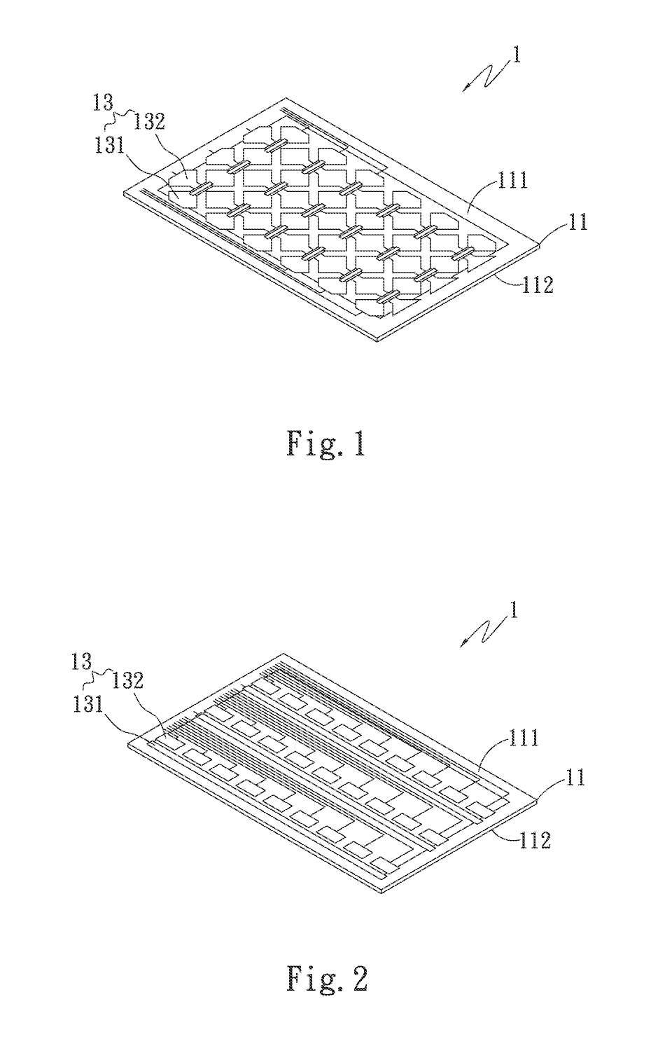

The present invention provides a polarization unit with touch functions, referring to FIGS. 1 and 2 which are perspective views of the polarization unit according to the first embodiment of the present invention from two different views. The polarization unit 1 includes a first polarization plate 11 and an inductive electrode layer 13. The first polarization plate 11 has a first side 111 and a second side 112 opposite to the first side 111. The second side 112 is for the user to perform the touch using a finger or a stylus.

Moreover, the inductive electrode layer 13 is disposed on the first side 111 of the first polarization plate 11. The inductive electrode layer 13 includes a plurality of first inductive electrodes 131 and a plurality of second inductive electrodes 132 which are either indium tin oxide (ITO) films or antimony tin oxide (ATO) films.

Also, in the preferred embodiment, the first and second inductive electrodes 131, 132 are interlaced each other, electrically insulated each other, and formed on the first side 111 of the first polarization plate 11 as an example for explanation (as shown in FIG. 1), but not limited to this. In practice, the designer can change the corresponding arrangement and patterns of the first and second inductive electrodes 131, 132 according to the requirements of touch-sensing sensitivity and layout space; for example, the first and second inductive electrodes 131, 132 are formed correspondingly on the first side 111 of the first polarization plate 11, as shown in FIG. 2.

Besides, the first and second inductive electrodes 131, 132 in the preferred embodiment are formed on the first side 111 of the first polarization plate 11 by sputtering as an example for explanation, but not limited to this. Sol-gel coating, electroplating, or evaporation also can be used.

By means of the design of the inductive electrode layer 13 disposed on the first polarization plate 11, the first polarization plate 11 can fulfill the touch functions. Further, the effects of convenient replacement and maintenance can be achieved.

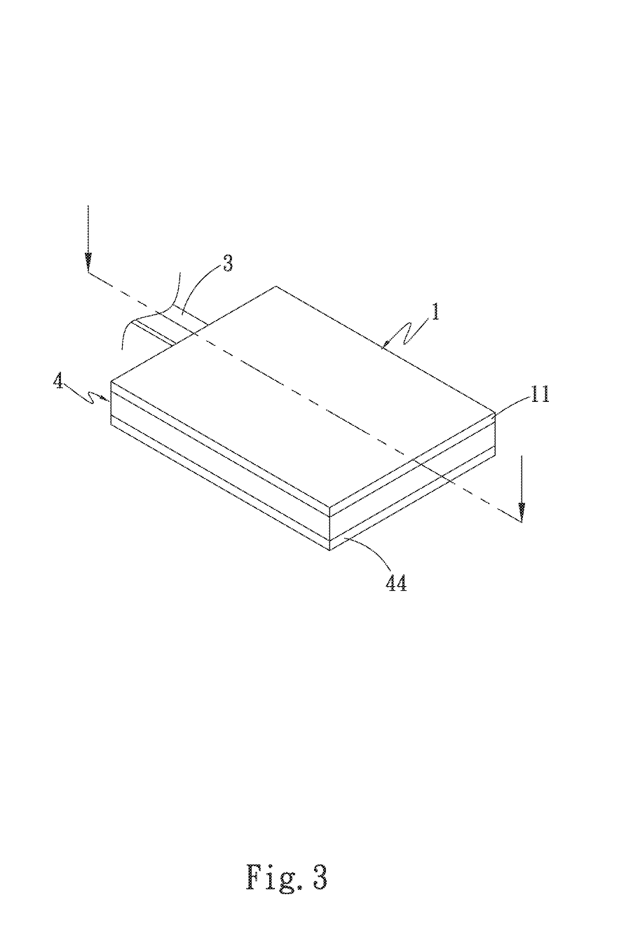

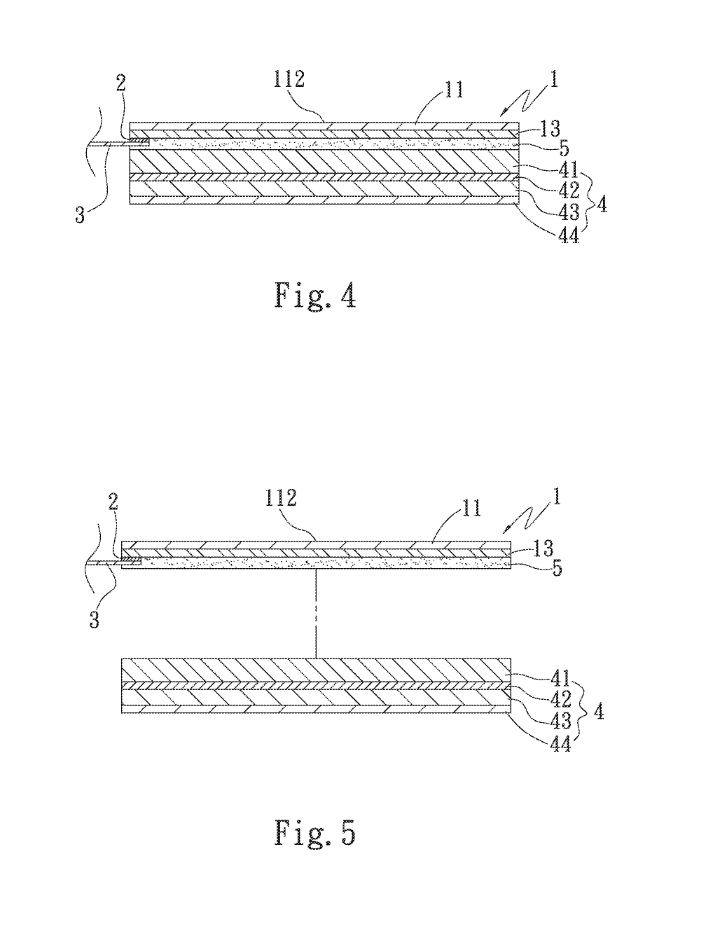

Please refer to FIGS. 3-5 which are the combined perspective view and cross-sectional views of the second preferred embodiment of the present invention, as well as FIG. 1. In the current preferred embodiment, the polarization unit 1 in the first embodiment is now applied to an LCD module 4. That is, the inductive electrode layer 13 on the first polarization plate 11 of the above polarization unit 1 is attached on the corresponding LCD module 4 having a first substrate 41, a liquid crystal layer 42, a second substrate 43, and a second polarization plate 44, wherein the liquid crystal layer 42 is disposed between the first and second substrates 41, 43, and the second polarization plate 44 is attached on the side of the second substrate 43 opposite to the liquid crystal layer 42; also, a backlight module (not shown) which provides a light source for the LCD module 4 is attached underneath the second polarization plate 44, in which the above first and second substrates 41, 43 are glass substrates, as an example for explanation.

Moreover, the structure, the relation of connection, and the effects of the polarization unit 1 in the current preferred embodiment are similar to those in the first embodiment, thus not described again here. The difference between them is that a conductive glue layer 2 is disposed on the above inductive electrode layer 13 and the conductive glue layer 2 in the current preferred embodiment is anisotropic conductive film (ACF) as an example for explanation, but not limited to this. One side of the conductive glue layer 2 is attached to the perimeter of one side of the conductive electrode layer 13 opposite to the first polarization plate 11 and the other side thereof is attached to one end of an FPC 3, whereby the FPC 3 is electrically connected to the inductive electrode layer 13 through the conductive glue layer 2.

Also, an adhesive layer 5 is disposed between the first substrate 41 and the corresponding inductive electrode layer 13. The adhesive layer 5 is optical clear adhesive (OCA), optical clear resin (OCR), or liquid adhesive lamination (LAL). The inductive electrode layer 13 and one end of the FPC 3 thereon are attached to the LCD module 4 to form a touch display device (that is, the so-called touch display device).

Consequently, the polarization unit 1 of the present invention is suitable for the LCD module 4 without touch functions. Only the upper polarization plate of the original LCD module 4 is directly replaced with the polarization unit 1 of the present invention and the resultant LCD module 4 can achieve the touch functions. In addition, compared with the embedded touch LCD device technology of the prior art, the present invention can simplify the production and assembling processes. For example, the number of manufacturing masks is reduced. As a result, the manufacturing yield is increased, and then the manufacturing cost is reduced.

Also, since the inductive electrode layer 13 of the present invention is disposed on the first polarization plate 11, when inspection is conducted during the manufacturing process, and damage or contact failure of the inductive electrode layer 13 is detected, only a new modularized polarization unit 1 is substituted or the damaged inductive electrode layer 13 is uninstalled to repair. It is not necessary to replace the substrate (that is, the glass substrate) of the new LCD module and thus the effects of convenient disassembling, replacement, and maintenance can be achieved.

In summary, the advantages of the present invention over the prior art are as follows:
1. The polarization unit of the present invention can be applied to the LCD module without touch functions and the resultant LCD module can achieve the touch functions;
2. The production and assembling processes are simplified and the manufacturing yield is increased; and
3. The manufacturing cost is reduced.

The above description is only about the preferred and feasible embodiments of the present invention. It will be understood that all variations of the above methods, shapes, structures, and apparatus according to the present invention should be embraced by the scope of the appended claims of the present invention.

What is claimed is:

1. A polarization unit with touch functions, including:
a first polarization plate having a first side and a second side opposite to the first side; and
an inductive electrode layer disposed on the first side of the first polarization plate.

2. The polarization unit with touch functions according to claim 1, wherein a conductive glue layer is disposed on the inductive electrode layer, wherein one side of the conductive glue layer is attached to the perimeter of one side of the conductive electrode layer opposite to the first polarization plate and the other side thereof is attached to one end of an FPC, whereby the FPC is electrically connected to the inductive electrode layer through the conductive glue layer.

3. The polarization unit with touch functions according to claim 2, wherein the inductive electrode layer includes a plurality of first inductive electrodes and a plurality of second inductive electrodes which are interlaced each other and electrically insulated each other and formed on the first side of the first polarization plate.

4. The polarization unit with touch functions according to claim 2, wherein the inductive electrode layer includes a plurality of first inductive electrodes and a plurality of second inductive electrodes, wherein the first and second inductive electrodes are formed correspondingly on the first side of the first polarization plate.

5. The polarization unit with touch functions according to claim 2, wherein the inductive electrode layer of the first polarization plate is attached on an LCD module having a first substrate, a liquid crystal layer, a second substrate, and a second polarization plate, wherein the liquid crystal layer is disposed between the first and second substrates, wherein the second polarization plate is attached on one side of the second substrate opposite to the liquid crystal layer, wherein an adhesive layer is disposed between the first substrate and the corresponding inductive electrode layer, wherein the inductive electrode layer and one end of the FPC thereon are attached to the LCD module to form a touch display device.

6. The polarization unit with touch functions according to claim 3, wherein the first and second inductive electrodes are either indium tin oxide films or antimony tin oxide films.

7. The polarization unit with touch functions according to claim 4, wherein the first and second inductive electrodes are either indium tin oxide films or antimony tin oxide films.

8. The polarization unit with touch functions according to claim 5, wherein the adhesive layer is either optical clear adhesive or optical clear resin.
